(19) United States
(12) Patent Application Publication
(10) Pub. No.: US 2011/0239897 A1
(43) Pub. Date: Oct. 6, 2011

(54) TRACK SUPPORT FOR MAGNETIC LEVITATION VEHICLES AND STATOR PACKET FOR THE SAME

(76) Inventor: Michael Horvat, Muenchen (DE)

(21) Appl. No.: 13/132,378

(22) PCT Filed: Dec. 3, 2009
(86) PCT No.: PCT/EP09/08607

§ 371 Date: Jun. 2, 2011

(51) Int. Cl. E01B 25/32; H02K 41/02; H02K 1/16

(52) U.S. Cl. 104/286; 310/12.09

(57) ABSTRACT

The invention relates to track supports for magnetic levitation vehicles, having at least one stator support (2) comprising a first mounting surface machined according to a preselected route, and having a plurality of stator packets (7) made of ferromagnetic sheet metal layers and mounted on the stator support (2), wherein the sheet metal layers comprise an upper longitudinal side having first cutouts and intermediate first bars, and a lower longitudinal side parallel to said first side, and wherein the first cutouts form first grooves (18) designed for positively receiving attachment bodies, and the lower longitudinal sides form a functional surface (29). The free ends of the first bars form a second mounting surface (22) adjacent to the first mounting surface, and the mounting bodies comprise T-nuts (23) disposed countersunk in the first grooves (18) and having threaded bores for mounting screws (26).

### PRIOR ART

The invention relates to a track support of the generic type described in the preamble to claim 1 and to a stator packet suitable therefor according to the preamble to claim 9.

Tracks for magnetic levitation vehicles composed, for example, of concrete or steel, comprise a multitude of track supports, which are arranged in sequence along a route and on which system-specific equipment such as lateral guide rails, slide rails, and stator packets are mounted (see e.g. DE 34 04 061 C1, DE-Z “Journal of Railway and Transport, Glaser's Annals” [Zeitschrift für Eisenbahn and Verkehr, Glasers Annalen] 105, 1981, no. 7/8, pages 205-215). Particular attention must be paid to the fastening of stator packets, which are composed of individual sheet metal plates and are components of a motor, preferably embodied in the form of a long-stator linear motor, serving as a drive unit for magnetic levitation vehicles, and are usually fastened from underneath to stator supports associated with the track supports. Up to this point, the stator packets have been fastened to the stator supports by means of crossbars, which were affixed only to the stator packets and rested against the stator supports (e.g. DE 39 28 278 C2, DE 197 03 497 A1, DE 102 24 148 A1, and DE 10 2004 028 947 A1) and through which fastening screws extended that were screwed into threaded bores in the stator support and/or into nuts associated with them and came to rest with their heads against the crossbars, subsequently being tightened with a high prestressing force.

For accurately positioned placement of the stator packets such that in the assembled state, their functional surfaces, which cooperate with lifting magnets of magnetic levitation vehicles, are parallel to a preselected route (spatial curve) while the undersides of the stator supports have correspondingly machined stop surfaces or mounting surfaces against which the tops of the crossbars rest, which are oriented parallel to the functional surfaces. These mounting surfaces, which serve as reference surfaces for the position of the stator packets and their functional surfaces, are preferably manufactured with the aid of computer-controlled tools (e.g. U.S. Pat. No. 4,698,895 and DE 202 10 808 U1), for example by means of material-removing machining, in particular milling.

Due to the above-described crossbars, the manufacture and installation of track supports of the generic type described at the beginning involves a comparatively high level of expense in terms of material and production (manufacture of crossbars and their attachment to the stator packets). In static terms, it is also noteworthy that the crossbars cause a small-scale load transfer, which results in unfavorable dynamics and relatively powerful forces and therefore, due to the high compressive load, is problematic particularly when track supports made of concrete are used. Also, cut-outs that are embodied in the sheet metal plates of the stator packets and serve to accommodate the crossbars result in the additional disadvantage that either a large amount of scrap is generated in the punching of the sheet metal plates or these cut-outs must be produced in a separate work step.

On the basis of this, the technical object of the present invention is to embody the track support of the generic type described at the beginning so that it is easier to manufacture, is subjected to less stress at discrete points during operation, and permits the sheet metal plates to be manufactured by means of a punching operation that does not generate a lot of scrap.

This object is attained by the defining characteristics of claims 1 and 9.

The invention has the advantage that the crossbars previously required for fastening the stator packets to the stator supports are completely eliminated. Inexpensive slot nuts can be used instead. The stator packets themselves have second mounting surfaces that come to rest against first mounting surfaces of the stator supports. This permits a contact of the second mounting surfaces over a large area, which results in low compressive loads on the stator supports. Also, instead of the crossbars, simple, inexpensive slot nuts are provided, which are accommodated entirely inside associated grooves of the stator packets and therefore do not come into contact with the stator supports.

Other advantageous features of the invention ensue from the dependent claims.

An exemplary embodiment of the invention will be described in greater detail below in conjunction with the accompanying drawings, whose depictions are shown in different scales.

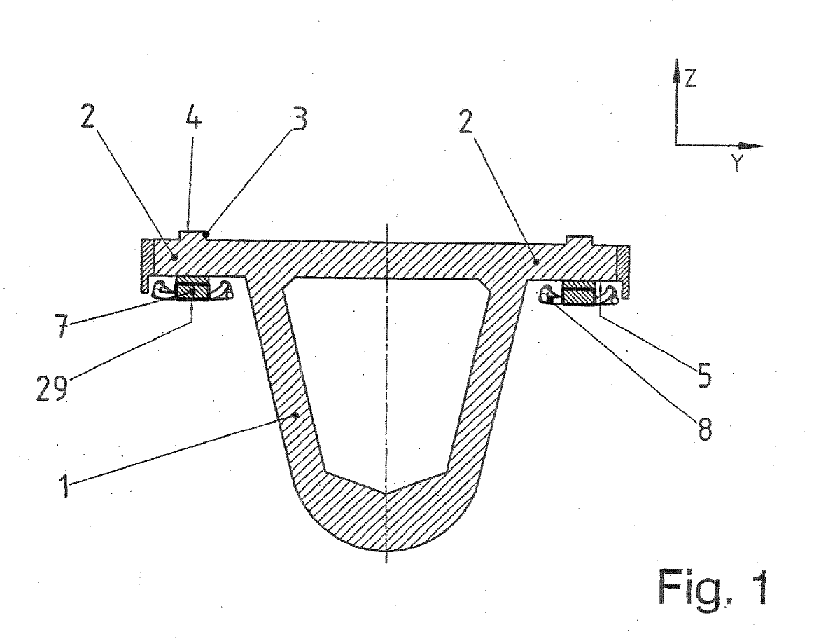

FIG. 1 is a schematic cross-section through a track support for magnetic levitation vehicles;

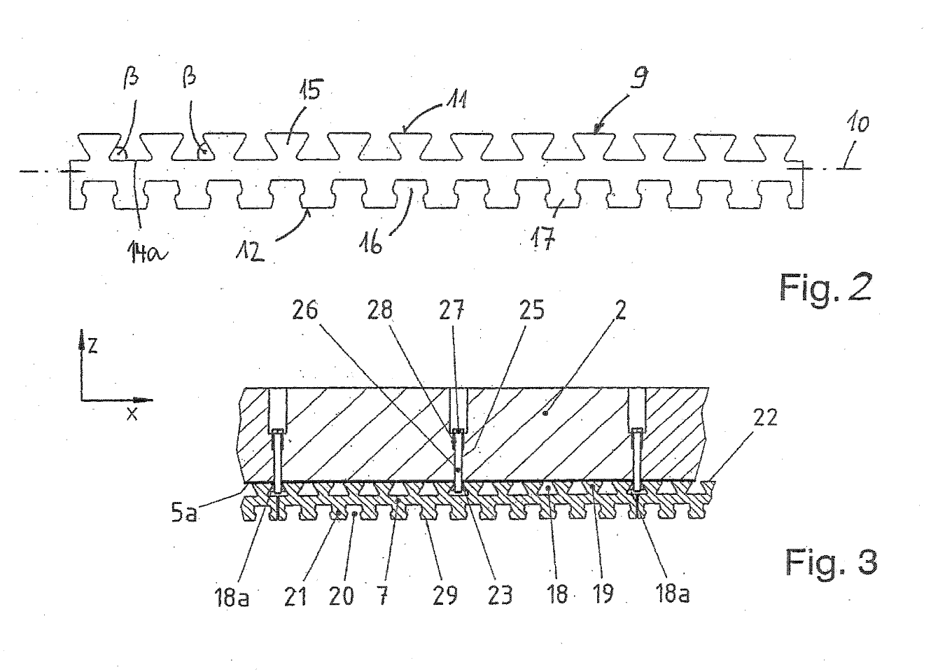

FIG. 2 is a side view of a sheet metal plate according to the invention for manufacturing a stator packet for the track support according to FIG. 1;

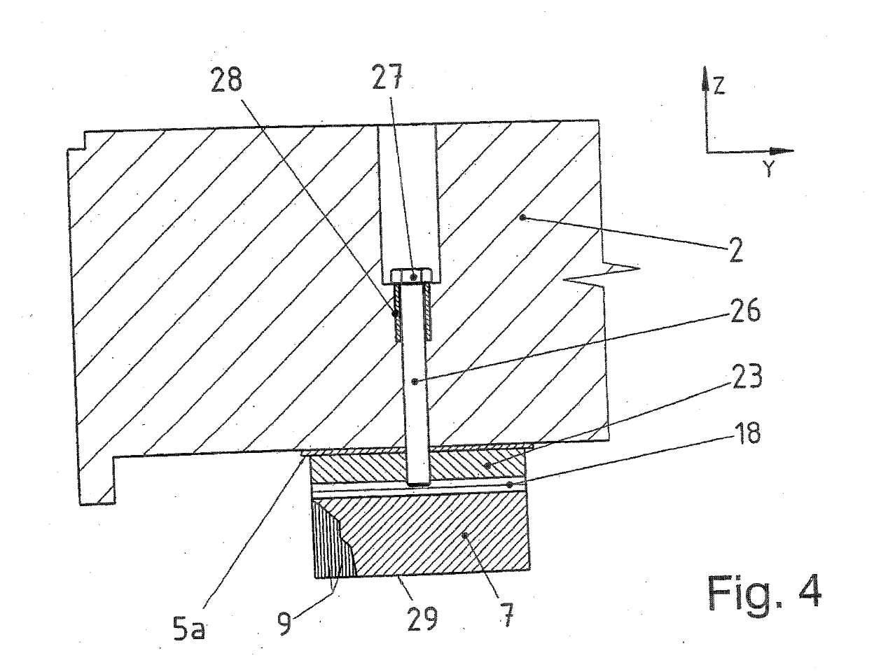

FIGS. 3 and 4 schematically depict a longitudinal section and a cross-section, respectively, through a cantilever arm that belongs to the track support according to FIG. 1 and is embodied for the installation of stator packets;

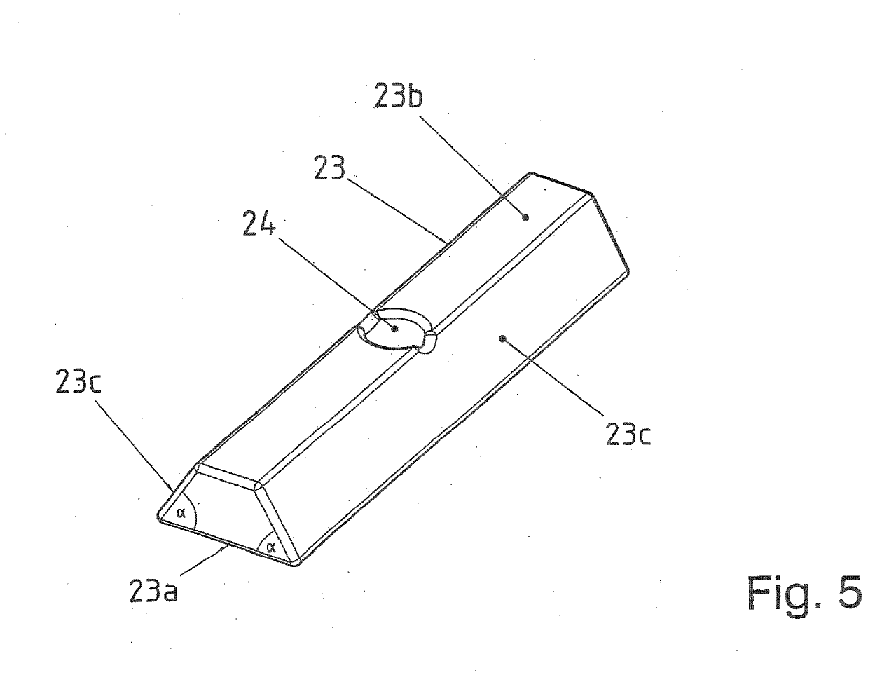

FIG. 5 is a very enlarged view of a slot nut according to the invention, which is embodied for the installation of a stator packet; and

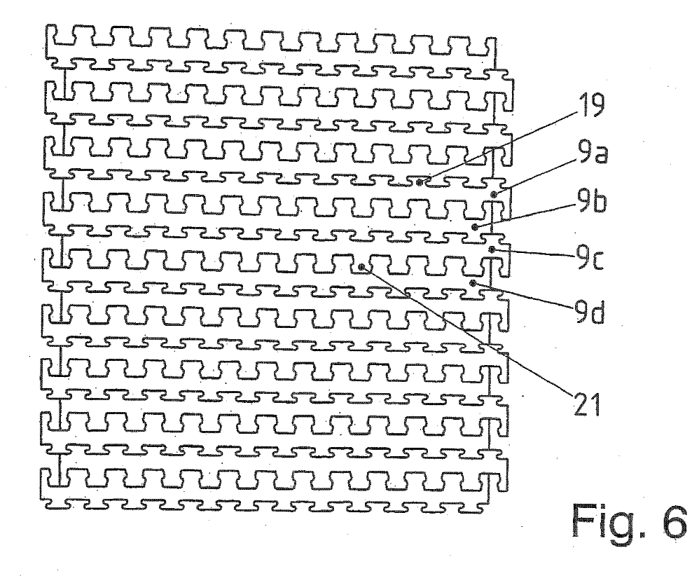

FIG. 6 shows a preferred cutting pattern for sheet metal plates embodied according to FIG. 2.

Tracks for magnetic levitation vehicles not shown in the drawings are usually composed of a multitude of track supports 1 that are arranged in series with one another in the direction of a preselected route and perpendicular to the plane of the drawing in FIG. 1. A known track support 1 of this kind is depicted in FIG. 1. In the exemplary embodiment, it is made of concrete and provided with laterally protruding cantilever arms 2. The cantilever arms 2 each have a projection 3, for example on their top surfaces, to form a sliding surface 4 on which the magnetic levitation vehicles can settle by means of skids that are attached to them. The cantilever arms 2 are also embodied as stator supports and are provided with first mounting surfaces 5 on their undersides. Both the sliding surfaces 4 and the first mounting surfaces 5 are embodied in accordance with the selected route and for this purpose, are obtained, for example, by subjecting the projections 3 and the undersides of the cantilever arms 2 to a material-removing, milling, or grinding machining with the aid of computer-controlled tools such as milling tools after the manufacture of the track support 1. While the sliding surface 4 suitably extends over the entire length of the support 1, the mounting surfaces 5 can either be embodied as likewise extending over the entire length of the support or embodied in the form of projections that are embodied similarly to the projections 3 and are spaced apart in the longitudinal direction and optionally also in the transverse direction of the track support 1. A special advantage of this design is that all track supports 1 can be manufactured from uniform (identical) blanks, whose projections 3 and mounting surfaces 5 can then be individually machined.

Conventional stator packets 7 embodied according to the prior art are attached to the underside of the cantilever arm or stator support 2 and are provided with teeth and grooves not shown in FIG. 1, which are arranged one after another in alternating fashion in the direction of a longitudinal axis, with the longitudinal axis defined as the travel direction of the magnetic levitation vehicles and alternatively defined in the drawing as the x-axis of a Cartesian coordinate system.

The grooves serve in a known way to accommodate three-phase windings 8 that are required for driving the magnetic levitation vehicles and together with the stator packets 7 form a long-stator linear motor, for example. The length of a stator packet 7 measured in the direction of the longitudinal axis, at 1 m or 2 m for example, is usually significantly smaller than the length of a track support 1 likewise extending in direction of the longitudinal axis.

Track supports 1 and stator packets 7 of this type are known for example from the above-mentioned publications, which are hereby incorporated by reference into the subject of the present disclosure in order to avoid repetition.

The stator packets 7 are assembled from a multitude of sheet metal plates 9 according to FIGS. 2 and 4 that are composed of a ferromagnetic material and each have a longitudinal axis 10. Because all of the sheet metal plates 9 are embodied identically, only the sheet metal plate 9 shown in FIG. 2 is explained in greater detail below. This sheet metal plate 9 has an upper longitudinal side 11 and a lower longitudinal side 12 parallel thereto, the terms “upper” and “lower” having been selected in accordance with their position in the final state in which they are fastened to the mounting surface 5 (FIGS. 1, 3 and 5). With a different assembly of the stator packets 7, the longitudinal sides 11 and 12 can naturally also assume positions other than upper and lower positions.

The upper longitudinal side 11 of each sheet metal plate 9 is provided with a plurality of first cut-outs 14 and interposed first dividers 15. The cut-outs 14 are arranged spaced apart from each other by preselected distances in the direction of the longitudinal axis 10 and, as explained below, are used to attach the stator packets 7 to the cantilever arm 2. In an exemplary embodiment of the invention considered to be the best up to now, the cut-outs 14 have trapezoidal or dovetail-shaped cross sections. Also, the underside of each sheet metal plate 9 is provided in a known manner with second cut-outs 16 and interposed second dividers 17 that are arranged in a preselected spacing pattern.

The stator packets 7 are produced by placing a plurality of sheet metal plates 9 with their broad sides resting against one another, i.e. stacking them, and then permanently connecting them to one another using a casting resin or another known technique. The resulting stator packets 7 are shown in FIGS. 3 and 4, from which it is apparent that the cut-outs 14, 16 and dividers 15, 17 are all aligned with one another, thus forming a plurality of parallel first grooves 18 and interposed ribs 19 on the top surface of the stator packets 7 and an alternating succession of second grooves 20 and interposed teeth 21 on the underside of the stator packets 7. The second grooves 20 serve in a known way to accommodate AC windings 8 (FIG. 1).

The first mounting surfaces 5 formed onto the undersides of the cantilever arms 2 are preferably planar or, if they are situated in the region of curves, hills, valleys, or the like, are composed of planar surface sections arranged one after another in polygon-like fashion, whose lengths match the lengths measured in the x-direction of the sheet metal plates 9 and hence of the stator packets 5. In addition, free ends of the ribs 19 remaining between the first grooves 18 abut an upper, preferably planar, second mounting surface 22 (FIG. 3) of the stator packets 7. All of the stator packets 7 are also preferably embodied identically. As a result, the stator packets 7 can be installed at any location along the track.

The stator packets 7 are fastened to the cantilever arms 2 or to the otherwise embodied stator supports, particularly in the way shown in FIGS. 3 and 4. For this purpose, the stator packets 7 are first placed with the second mounting surfaces 22 against the first mounting surfaces 5 (or corresponding sections of); a glue layer 5a, for example, can be provided for the initial temporary attachment. The final fixing of the stator packets 7 is then carried out with the aid of fastening elements in the form of slot nuts 23 (also see FIG. 5), which are inserted from the side into the first grooves 18 before or after the stator packets 7 are placed against the mounting surfaces 5. In their middle region, these slot nuts 23 have at least one preferably continuously embodied threaded bore 24, which, in the inserted installation position of the stator packets 7 and slot nuts 23 shown in FIGS. 3 and 4, is situated essentially vertically, i.e. in the z-direction of the imaginary coordinate system. Because the slot nuts 23 and hence also their threaded bores 24 are not easily accessible from the outside after the slot nuts 23 have been inserted into the first grooves 18, the cantilever arms 2 have bores 25 extending in the z-direction and spaced apart from one another in the x-direction, which pass completely through the cantilever arms 2 and into which a respective fastening screw 26 can be inserted from the side of the cantilever arms 2 opposite from the mounting surface 5. Therefore as they are placed against the first mounting surface 5, the stator packets 7 only have to be aligned relative to the cantilever arm 2 so that their threaded bores 24 are each aligned with one of the bores 25. Then, as shown in FIGS. 3 and 4, it is only necessary to insert fastening screws 26 into the bores 25 and screw their ends into the threaded bores 24 of the relevant slot nuts 23 until the heads 27 at their other ends come to rest against the cantilever arms 2. To protect the material—e.g. concrete—of the cantilever arms 2, a sleeve 28 composed of steel or the like for supporting the head 27 can also be inserted into the enlarged, stepped upper sections of the bores 25. It is alternatively possible to use suitable washers or the like. In addition, as shown in FIGS. 3 and 4, the heads of 27 of the fastening screws 26 can also be embodied as countersunk into the cantilever arms 2.

A corresponding assembly of the stator packets 7 is possible if the cantilever arms 2 do not serve directly as stator supports, but instead components formed onto them or attached to them perform this function.

By contrast with the known fastening of stator packets 7, as shown in FIGS. 3 and 4, instead of being performed by crossbars protruding beyond their second mounting surface 22, this function is performed by the slot nuts 23 accommodated in recessed fashion in the first grooves 18. In order to be able to nevertheless place the stator packets 7 firmly against the first mounting surfaces 5 and tighten the fastening screws 26 with the required amount of prestressing force, the slot nuts 23 are preferably embodied in accordance with FIG. 5. In the exemplary embodiment, they have trapezoidal (or truncated cone-shaped) cross-sections and as a result, each have a bottom surface 23a, a top surface 23b parallel thereto, and two side surfaces 23c, which are arranged with identical, opposing, acute base angles α relative to the bottom surface 23a. The base angles α are preferably selected to be precisely equal to the angle β (FIG. 2) with which side walls—which delimit the sides of first cut-outs 14—are aligned relative to bottom surfaces 14a—which delimit the bottoms of the first cut-outs 14. A height of the slot nut 23 measured between the bottom surface 23a and the top surface 23b is less than the distance of the bottom surfaces 14a of the first cut-outs 14 from the top longitudinal side 11 of the sheet metal plates 9. In addition, the arrangement is such that the slot nuts 23 in the grooves 18 can in fact be moved in a limited fashion in the z-direction, but their side surfaces 23c come into contact with the sides walls of the grooves 18 before the top surfaces 23b of the slot nuts 23 reach the edges of the grooves 18 that are open toward the mounting surface 21. Consequently, as the fastening screws 26 are being tightened, the slot nuts 23 are first pressed against the sides of the grooves 18, thus permitting them to be fixed in the z-direction and permitting the fastening screws 26 to be tightened. For a stable connection, the slot nuts 23 also have lengths in the y-direction that correspond to the lengths of the first slots of the stator packets 7 measured in the same direction.

As FIGS. 3 and 4 indicate, in the assembled state, the slot nuts 23 are secured in both the z-direction and the x-direction with form-locked engagement; in the y direction, however, they are secured by frictional engagement, i.e. by means of a clamping action and surface pressure, which after the tightening of the fastening screws 26, is sufficient to prevent the stator packets 7 from moving in this direction. Apart from this, possible movements in the y-direction are limited so that the fastening screws 26 are preferably situated with only a slight radial play in the bores 25 of the cantilever arms 2. If necessary, it is also possible for the slot nuts 23 to be affixed in the grooves by gluing, for example.

Free ends of the teeth 21 of the stator packets 7 abut a preferably planar functional surface 29 of the stator packets 7, which is situated parallel to the second mounting surface 22. Its distance from the sliding surface 4 (FIG. 1) constitutes the so-called guideway depth, which is especially important for the operation of magnetic levitation vehicles when the stator packets 7 cooperate with lifting magnets that are mounted on the magnetic levitation vehicles and cause the levitation to occur while at the same time producing the excitation field of a long-stator linear motor. According to the invention, this guideway depth is set by selecting an appropriate height of the sheet metal plates 9 measured between the upper and lower longitudinal sides 11 and 12. Since these very sheet metal plates 9—or more precisely stated, the second mounting surfaces 22 of the stator packets 7 formed by them—unlike in the prior embodiment, rest directly against the first mounting surface 5 of the cantilever arms 2, this height of the sheet metal plates 9 contributes, also directly, to the guideway depth. In particular, this height is selected so that the sheet metal plates 9 bridge the space previously occupied by the crossbars.

In another preferred embodiment of the invention, the sheet metal plates 9 according to FIG. 2 are provided with a multitude of first cut-outs 14 situated at preselected intervals all along their upper longitudinal side 11. Of these cut-outs 14 and the first grooves 18 formed by them, however, only a small number are used to fasten the stator packets 7 to the cantilever arm 2. As depicted in FIGS. 2 and 3, a stator packet 7 has for example eleven whole first grooves 18 and a respective half first groove 18a at each of its two ends. The fastening, however, uses only one central groove 18 and the two half-grooves 18a, which are each completed by a corresponding half-groove 18a of an adjacent stator packet 7 so that they form a whole groove 18, which is useful for facilitating assembly.

The embodiment of a variety of first cut-outs 14 (FIG. 2), only a small fraction of which is required for the fastening of the stator packets 7, has two advantages. On the one hand, this conserves material in the manufacture of the sheet metal plates 9 without simultaneously preventing the stator packets 7 from contacting the cantilever arms 2 over a large area. Particularly if the trapezoidal shape from FIGS. 2 and 3 is used for the first cut-outs 14, the free ends of all of the first dividers 15 together constitute sufficiently large second mounting surfaces 22, making it possible to achieve low surface pressures. On the other hand, providing the continuous series of first cut-outs 14 on the one hand makes it possible to achieve a cutting pattern that produces very little waste in the manufacture of the sheet metal plates 9 by punching, laser cutting, or the like, while on the other hand avoids the necessity of a second work step for producing the cut-outs 14 required to accommodate the slot nuts 23. FIG. 6 shows an example of this with a plurality of sheet metal plates, in particular four sheet metal plates 9a to 9d, where on the one hand, both the sheet metal plates 9a and 9b and the sheet metal plates 9c and 9d are interconnected with their first cut-outs 14 and first dividers 15 facing one another and on the other hand, the sheet metal plates 9b and 9c are interconnected with their second cut-outs 16 and second dividers 17 facing one another. If this tooth pattern shown in FIG. 6 is used for a punching and/or cutting process, then this means that the cut-outs 14, 16 and dividers 15, 17 of the sheet metal plates 9 are shaped so that with the alternating contact of the upper and lower longitudinal sides 11 and 12 of a plurality of sheet metal plates, the cut-outs 14 and dividers 15 on the one hand and the cut-outs 16 and dividers 17 on the other hand always engage in one another or are interconnected with one another in pairs.

The invention is not limited to the exemplary embodiment described, which can be modified in many ways. This applies first of all to the shapes of the first and second cut-outs 14, 16, the shapes of the interposed dividers 15, 17 of the sheet metal plates 9, and the shapes of the slot nuts 23 shown in FIGS. 2, 3 and 6. Instead of trapezoidal shapes, other shapes are also possible, provided that they allow a form-locking engagement of correspondingly shaped slot nuts in the z-direction. Preferably, however, the selected shapes are always embodied as interlocking in jigsaw-puzzle fashion like the ones shown in FIG. 6. It is also conceivable for there to be sheet metal plates 9 that have no cut-outs and dividers on their lower longitudinal sides, but are instead embodied as smooth (planar), particularly if the magnetic levitation vehicles are driven in a manner other than the one described and the stator packets are only intended to perform the “lifting” function. It is also clear that according to FIG. 1, corresponding stator packets can be mounted on both sides of the track. It is also possible for the height difference occurring due to the elimination of the crossbars to be compensated for by using cantilever arms 2 that are taller in the z-direction instead of using thicker sheet metal plates. The above-described sheet metal plates 9, however, have the special advantage that the stator packets 7 manufactured from them can be used in combination with the already existing track supports 1 and their cantilever arms 2, without having to structurally alter the latter. Furthermore, the above-described fastening of the stator packets 7 can be embodied in an intrinsically known, redundant way in that the stator packets 7 are each fastened to a respective slot nut 23, for example only at the front and rear ends. However, a central slot nut, for example shown in FIG. 3, is mounted so that in the event that the front or rear fastening screw breaks, the stator packet 7 can drop slightly, thus forming a gap between the mounting surfaces 5 and 22. On the one hand, this gap can then be automatically detected by sensors provided on the magnetic levitation vehicles and on the other hand, it is so small that it can still be safely passed over several times by magnetic levitation vehicles, thus allowing sufficient time for a repair. Apart from this, the invention naturally also includes the above-described stator packets 7. These could alternatively be attached solely by means of gluing, for example by means of the glue layer 5a, to the cantilever arm 2 or the like, in which case the slot nuts 23 could be used solely to provide the desired redundancy. Finally, it is self-evident that the various defining characteristics can also be used in combinations other than the ones described and portrayed above.

What is claimed is:

1. A cable connecting device (10) having a housing (12, 44) and an electrically conductive bypass element (14); a first electrical line (16), which has an internal current-carrying core (18) and an insulating covering (20), is routable through the housing (12, 44) of the cable connecting device (10) via the bypass element (14) in that it is possible for the line (16) to be inserted into at least one first recess (22, 24) of the bypass element (14), with the size of the first recess (22, 24) corresponding to or being slightly smaller than the diameter of the current-carrying core (18) of the electrical line (16), and the bypass element (14) has at least one second recess (26, 28) for at least one second electrical line (30), which has an internal current-carrying core (32) and an insulating covering (34), with the size of the second recess (26, 28) being adapted to or slightly smaller than the cross-section of the current-carrying core (32) of the second electrical line (30).

2. The cable connecting device (10) as recited in claim 1, wherein the recesses (22, 24, 26, 28) have an essentially semicircular bottom (62) for accommodating the current-carrying core (18, 32) of the lines (16, 30).

3. The cable connecting device (10) as recited in claim 2, wherein the recesses (22, 24, 26, 28) have an insertion and cutting slot (64) that narrows continuously in the direction from the recess openings (60) to the bottom (62) of the recesses (22, 24, 26, 28).

4. The cable connecting device (10) as recited in claim 1,
wherein the bypass element (14) is embodied as sharp-edged in the edge region of the recesses (22, 24, 26, 28) in order to cut open the insulating covering (20, 34).

5. The cable connecting device (10) as recited in claim 1,
wherein the bypass element (14) has a front and rear recess (22, 24, 26, 28) for each electrical line (16, 30).

6. The cable connecting device (10) as recited in claim 5, wherein the bypass element (14) is embodied in the shape of a frame; a front frame side of the bypass element (14) is provided with front recesses (22, 26) and a rear frame side of the bypass element (14) is provided with rear recesses (24, 28).

7. The cable connecting device (10) as recited in claim 1,
wherein the housing (42) has two housing halves (12, 44) that are able to engage each other in detent fashion.

8. The cable connecting device (10) as recited in claim 7, wherein the housing halves (12, 44) are able to irreversibly engage each other in detent fashion.

9. The cable connecting device (10) as recited in claim 7,
wherein a bypass element (14) is provided for each housing half (12, 44) and when the housing halves (12, 44) engage each other in detent fashion, the bypass elements (14) are able to press against the lines (16, 30) from all sides.

10. The cable connecting device (10) as recited in claim 9, wherein the bypass elements (14) have at least one detent element (36) and at least one detent receptacle (38).

11. The cable connecting device (10) as recited in claim 7,
wherein the housing halves (12, 44) and the bypass elements (14) are embodied symmetrically.

12. The cable connecting device (10) as recited in claim 1,
wherein the housing (42) is provided with at least one entry opening (50) and at least one exit opening (52) for introducing a filler material into the housing interior (58).

13. The cable connecting device (10) as recited in claim 1,
wherein the entry opening (50) is situated centrally on the housing (42) and the exit opening (52) is situated in an outer region of the housing (42).

14. The cable connecting device (10) as recited in claim 1,
wherein it is possible for a pressurized hot melt adhesive functioning as a filler material to be injected into the detent-engaged housing (42).

15. A use of a cable connecting device (10) as recited in claim 1 for constructing a photovoltaic system.
